(19) United States
(12) Patent Application Publication
(10) Pub. No.: US 2021/0123812 A1
(43) Pub. Date: Apr. 29, 2021

(54) AIRCRAFT SENSOR MODULE AND AIRCRAFT SENSOR SYSTEM

(71) Applicant: MITSUBISHI HEAVY INDUSTRIES, LTD., Tokyo (JP)

(72) Inventors: Nobuyuki KAMIHARA, Tokyo (JP); Yuki YANO, Tokyo (JP); Kiyoka TAKAGI, Tokyo (JP)

(21) Appl. No.: 16/635,724

(22) PCT Filed: Aug. 15, 2018
(86) PCT No.: PCT/JP2018/030376

§ 371 Date: Jan. 31, 2020

(30) Foreign Application Priority Data
Sep. 27, 2017 (JP) 2017-186423

(51) Int. Cl. G01K 1/14; H02J 50/00; H02J 7/00; B64D 41/00; G08C 17/06

(52) U.S. Cl. CPC G01K 1/14; H02J 50/001; G08C 17/06; B64D 41/00; H02J 7/0068

(57) ABSTRACT

An aircraft sensor system includes an aircraft sensor module provided in an aircraft. The sensor module is an outdoor temperature sensor module configured to measure outdoor temperature of the aircraft. The sensor module includes an energy harvesting element configured to generate power from vibration generated by the aircraft; a power storage unit configured to store power generated by the energy harvesting element; a sensor configured to operate by the power from at least one of the energy harvesting element and the power storage unit; and a wireless communication unit configured to operate by at least one of the power from the energy harvesting element and the power from the power storage unit, and transmit measurement data measured by the sensor to an external device via wireless communication. The sensor module is provided to a wing tip end portion that is a free end of a wing body of the aircraft.

### TECHNICAL FIELDE

The present invention relates to an aircraft sensor module and an aircraft sensor system provided in an aircraft.

### BACKGROUND ART

In the prior art, one known sensor system including a sensor module provided in an aircraft is a wireless sensor system used for measuring the amount of fuel in an aircraft fuel tank (see, for example, Patent Document 1). The wireless sensor system includes a capacitive probe and a wireless communication unit. The wireless communication unit uses the capacitive probe as a transmission antenna to perform wireless communication.

### CITATION LIST

### Patent Document

Patent Document 1: JP 2016-38911 A

### SUMMARY OF INVENTION

### Technical Problem

However, using a sensor system that performs wired communication means that a communication cable needs to be laid, and laying a communication cable in an aircraft increases the total weight of the aircraft. In order to operate the sensor system, a power supply cable for supplying power needs to be provided, but laying a power supply cable in an aircraft increases the total weight of the aircraft.

Therefore, an object of the present invention is to provide an aircraft sensor module and an aircraft sensor system that is lighter and can provide a simpler power supply system.

### Solution to Problem

An aircraft sensor module according to an embodiment of the present invention is an aircraft sensor module provided in an aircraft and includes an energy harvesting element configured to generate power by utilizing internal and external environments of the aircraft, a power storage unit configured to store power generated by the energy harvesting element, a sensor configured to operate by at least one of the power from the energy harvesting element and the power from the power storage unit, and a wireless communication unit configured to operate by at least one of the power from the energy harvesting element and the power from the power storage unit, and also transmit measurement data measured by the sensor to an external device via wireless communication.

According to this configuration, the sensor and the wireless communication unit can be operated using power generated by the energy harvesting element. As a result, the sensor and the wireless communication unit need not be supplied with power via a wire, and hence the power supply system can be simplified. Further, since the measurement data can be wirelessly transmitted by the wireless communication unit, there is no need to transmit the measured data via a wire, and hence a wired communication cable can be omitted and weight can be reduced.

Preferably, the energy harvesting element is an element configured to generate power from at least one of vibration generated by the aircraft and heat generated by the aircraft.

According to this configuration, the energy harvesting element can generate power from vibration generated at a wing tip end portion, which is a free end of the wing body of the aircraft, and vibration and heat around the engine of the aircraft.

Preferably, a plurality of the energy harvesting elements are provided, and the plurality of energy harvesting elements are connected to the power storage unit and configured to supply power to the power storage unit.

According to this configuration, since the energy harvesting elements can be multiplexed, power can be supplied from the energy harvesting elements to the power storing unit more reliably.

Preferably, the wireless communication unit is configured to transmit the measurement data in a long cycle having a longer length than an initial cycle that is initially set.

According to this configuration, since the wireless communication unit can communicate less frequently, power consumption used for communication can be reduced. Therefore, an energy harvesting element with low power generating capacity can be used.

An aircraft sensor system according to an embodiment of the present invention includes the above-described aircraft sensor module mounted to an aircraft, and a data receiver configured to receive the measurement data transmitted from the sensor module.

According to this configuration, since the measurement data can be communicated wirelessly and power does not need to be supplied via a wire, weight can be reduced and the power supply system can be simplified.

Preferably, the sensor module is configured to transmit the measurement data measured by the sensor to the data receiver a plurality of times and the data receiver is configured to generate normalized measurement data by performing normalization on the basis of a plurality of the measurement data received from the sensor module.

According to this configuration, since normalized measurement data can be generated from a plurality of the measurement data, the reliability of the normalized measurement data can be increased.

Preferably, the sensor module is an outdoor temperature sensor module configured to measure outdoor temperature of the aircraft, and the sensor module is provided to a wing tip end portion that is a free end of a wing body of the aircraft.

According to this configuration, the outdoor temperature of the aircraft can be appropriately measured by providing the sensor module at the wing tip end portion, and the energy harvesting element of the sensor module can suitably generate power at the wing tip end portion, which is likely to vibrate.

Preferably, a plurality of the sensor modules of same type are provided, and each of the plurality of the sensor modules is configured to transmit the measurement data to the data receiver.

According to this configuration, since the sensor module can be multiplexed, reliability in transmitting the sensor data from the sensor module to the data receiver can be increased.

Preferably, the aircraft sensor system further includes an emergency power supply and a wired power supply line configured to supply power from the emergency power supply to the sensor module via a wire.

According to this configuration, since power can be supplied to the sensor module in an emergency via a wire, reliability of the sensor system in an emergency can be increased.

### BRIEF DESCRIPTION OF DRAWINGS

FIG. 1 is a schematic view of an aircraft provided with a sensor system according to a first embodiment.

FIG. 2 is a diagram illustrating a configuration of the sensor system according to the first embodiment.

FIG. 3 is a diagram illustrating transmission timing of sensor data by the sensor system according to the first embodiment.

FIG. 4 is a schematic view of an aircraft provided with a sensor system according to a second embodiment.

FIG. 5 is a diagram in which the mounting position, type, and applied energy harvesting element of the sensor module are associated with each other.

### DESCRIPTION OF EMBODIMENTS

Detailed descriptions will be given below of embodiments according to the present invention on the basis of the drawings. Note that, the invention is not limited to the embodiments. Further, the constituent elements in the following embodiments include those that can be easily replaced by a person skilled in the art or those that are substantially the same. Further, the constituent elements described below can be combined as appropriate, and in case of a plurality of embodiments, the embodiments can be combined with one another.

### First Embodiment

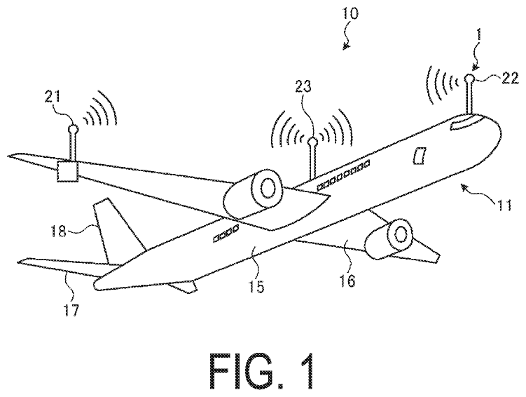

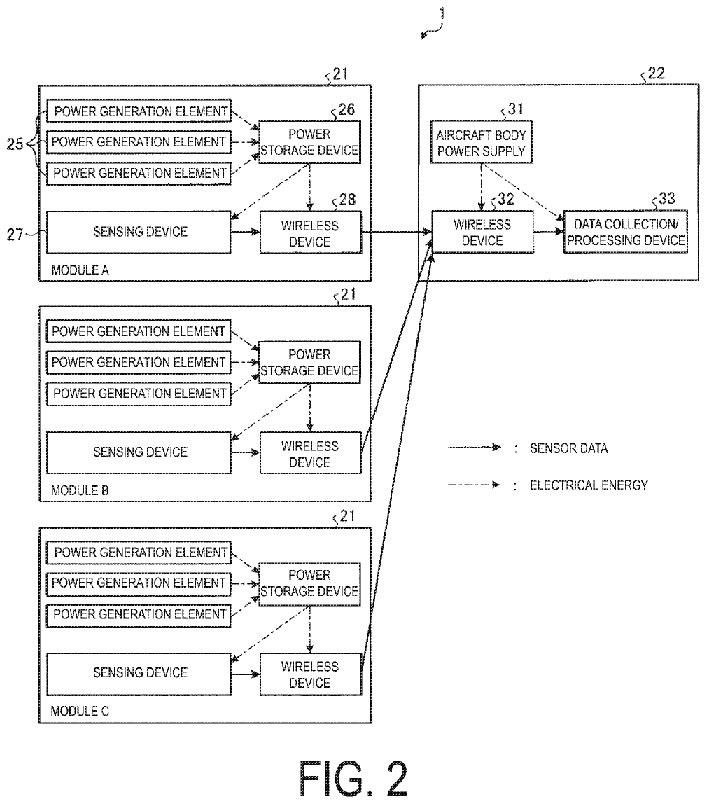

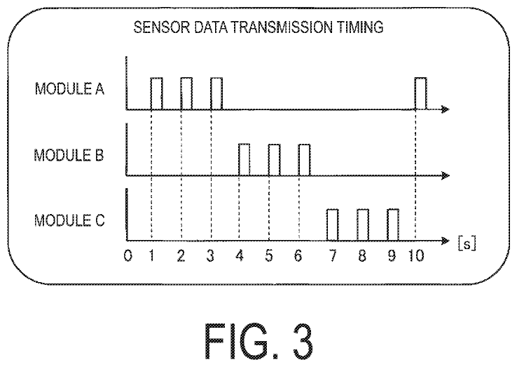

FIG. 1 is a schematic view of an aircraft provided with a sensor system according to a first embodiment. FIG. 2 is a diagram illustrating a configuration of the sensor system according to the first embodiment. FIG. 3 is a diagram illustrating transmission timing of sensor data by the sensor system according to the first embodiment.

The sensor system 1 according to the first embodiment is a system installed in an aircraft 10 and, for example, configured to perform sensing as a health monitor for the aircraft 10. The aircraft 10 according to the first embodiment includes an aircraft body 11 and the sensor system 1 installed to the aircraft body 11.

First, the aircraft body 11 will be briefly described. The aircraft body 11 includes a fuselage 15, main wings 16, horizontal stabilizers 17, and a vertical stabilizer 18. The fuselage 15 is a tubular member that extends in a roll axis direction, which is a direction that connects the nose and the tail of the aircraft 10. The main wings 16 are wing members provided near central portions of the fuselage 15 and extend outward from the fuselage 15 in a pitch axis direction orthogonal to the roll axis direction. The horizontal stabilizers 17 are wing members provided closer on the tail of the fuselage 15 and extend outward from the fuselage 15 in the pitch axis direction. The vertical stabilizer 18 is a wing member provided closer on the tail of the fuselage 15 and extends outward from the fuselage 15 in a yaw axis direction orthogonal to both the roll axis direction and the pitch axis direction.

Next, the sensor system 1 will be described with reference to FIG. 2. The sensor system 1 includes a plurality of sensor modules 21 and a data receiver 22. Sensor data (measurement data) measured by each sensor module is transmitted to the data receiver 22. Note that the sensor system 1 may include a relay system 23 (see FIG. 1) configured to relay the sensor data transmitted from each sensor module 21 to the data receiver 22.

Each sensor module 21 includes a plurality of energy harvesting elements 25, a power storage device (power storage unit) 26, a sensing device (sensor) 27, and a wireless device (wireless communication unit) 28.

The energy harvesting element 25 is an element configured to generate power by utilizing internal and external environments of the aircraft 10 and is the element configured to generate power from vibration generated by the aircraft 10 and heat generated by the aircraft 10. Examples of the energy harvesting element 25 include a piezoelectric element configured to generate power from vibrations generated by the aircraft 10, a Peltier element configured to generate power from a difference in temperature, a photovoltaic power generation element configured to generate power from sunlight, and the like. A plurality of the energy harvesting elements 25 are provided in multiplexed manner with respect to the power storage device 26. Each of the energy harvesting elements 25 is electrically connected to the power storage device 26. Accordingly, the plurality of energy harvesting elements 25 are configured to be able to stably supply power generated by the energy harvesting elements 25 to the power storage device 26.

The power storage device 26 stores power supplied from the energy harvesting elements and supplies the stored power to a sensing device 27 and a wireless device 28. An electric double layer capacitor, for example, is used as the power storage device 26. Because the electric double layer capacitor has a low charge/discharge depth limit, the electric double layer capacitor can suitably store power even when the power supplied from the energy harvesting elements 25 is unstable. Further, because the electric double layer capacitor has a high charge/discharge density, power can be suitably supplied to the sensing device 27 and the wireless device 28. The electric double layer capacitor also has a large operating temperature range. Thus, the electric double layer capacitor is suited for use in an aircraft, where outdoor temperature of the aircraft is low.

The sensing device 27 is a sensor configured to measure various physical quantities in the aircraft 10, and is, for example, a temperature sensor including an outdoor temperature sensor configured to measure outdoor temperature. The sensing device 27 operates by power supplied from the power storage device 26. The sensing device 27 outputs measured physical quantities as sensor data to the wireless device 28.

The wireless device 28 operates by power supplied from the power storage device 26. The wireless device 28 transmits the sensor data input from the sensing device 27 to the data receiver 22 via wireless communication. In this embodiment, the wireless device 28 is configured to multiplex the measured sensor data by transmitting the sensor data to the data receiver 22 multiple times.

A plurality of the sensor modules 21 described above are provided in a multiplexed manner with respect to the data receiver 22. The sensor data transmitted from the plurality of sensor modules 21 to the data receiver 22 is transmitted at the transmission timing illustrated in FIG. 3. More specifically, as illustrated in FIG. 3, three sensor modules 21 (modules A, B and C) are provided. The sensor data is transmitted to the data receiver 22 from the three sensor modules 21 and three lots of sensor data are transmitted from each sensor module. In other words, in terms of the transmission timing of the sensor data, the sensor data from the sensor module 21 serving as the module A is continuously transmitted three times, then the sensor data from the sensor module 21 serving as the module B is continuously transmitted three times, and then the sensor data from the sensor module 21 serving as the module C is continuously transmitted three times. Then, the sensor data from the sensor module 21 serving as the module A is once again continuously transmitted three times and the sensor data is transmitted at the same transmission timing thereafter.

The data receiver 22 includes an aircraft body power supply 31, a wireless device 32, and a data collection/processing device 33.

The aircraft body power supply 31 is a fixed power supply that is configured to stably supply power. The wireless device 32 operates by power supplied by the aircraft body power supply 31. The wireless device 32 receives the sensor data transmitted from the wireless device 28 of the sensor module 21. The wireless device 32 outputs the received sensor data to the data collection/processing device 33.

The data collection/processing device 33 processes the received sensor data and stores the processed sensor data. The data collection/processing device 33 operates by power supplied by the aircraft body power supply 31. The data collection/processing device 33 receives input of a plurality of sensor data from the plurality of sensor modules 21 via the wireless device 32. Thus, the data collection/processing device 33 normalizes the plurality of sensor data, generates normalized sensor data (normalized measurement data) from the sensor data that was normalized, and stores the normalized sensor data.

Any method may be used to normalize the plurality of sensor data. The following five methods are described as examples of such a method. As a first normalization method, the median sensor data among the plurality of sensor data is defined as the normalized sensor data. As a second normalization method, the average value of the plurality of sensor data is defined as the normalized sensor data. As a third normalizing method, deriving the absolute value of the difference between two sensor data among the plurality of sensor data, and the average value of the two sensor data with the minimum derived absolute value is defined as the normalized sensor data. As a fourth normalization method, excluding sensor data that is farthest from the average value of the plurality of sensor data, and the average value of the remaining sensor data is defined as the normalized sensor data. As a fifth normalizing method, deriving a standard deviation σ from the plurality of sensor data, excluding sensor data far from the median ±Xσ, and the average value of the remaining sensor data is defined as the normalized sensor data.

In the sensor system 1 described above, the sensing device 27 and the wireless device 28 of the sensor module 21 are operated by power generated by the energy harvesting elements 25 via the power storage device 26. The sensor system 1 then generates sensor data in the plurality of sensor modules 21 and transmits the generated sensor data to the data receiver 22. Then, the sensor system 1 performs normalization processing on the sensor data in the data receiver 22 to generate the normalized sensor data and stores the generated normalized sensor data.

Now, the type of the sensor module 21 and the mounting position of the sensor module 21 will be described. When the sensing device 27 of the sensor module 21 is an outdoor temperature sensor that measures outdoor temperature, i.e., the sensor module 21 is an outdoor temperature sensor module, the outdoor temperature sensor module is provided at the main wing 16 of the aircraft body 11 closer the tip of the wing (tip end portion of wing). In addition, when the sensor module 21 is an outdoor temperature sensor module, a piezoelectric element configured to generate power from vibration is used as the energy harvesting element. This is because vibration is more likely to occur closer to the tip of the main wing 16 of the aircraft body 11, which can provide stable power generation from vibration. This position is also suitable for measuring outdoor temperature.

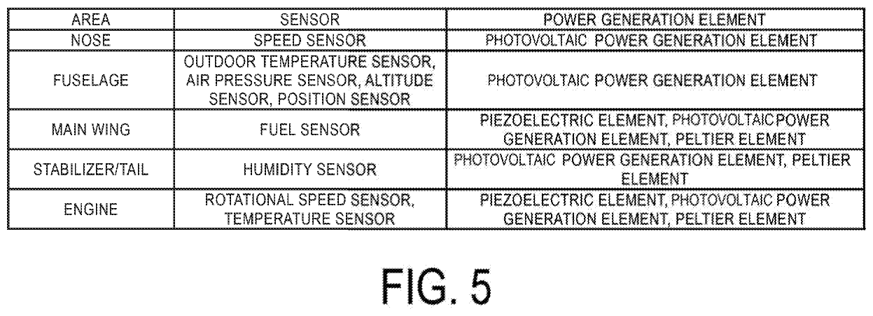

Now referring to FIG. 5, the mounting position (area) of the sensor module 21, the type of the sensor module 21, and the applied energy harvesting element will be described. FIG. 5 is a diagram in which the mounting position, type of the sensor module and the applied energy harvesting element are associated with each other. The sensing device 27 provided to a nose cone provided on the fuselage 15 of the aircraft 10 closer to the nose of the fuselage 15 includes a speed sensor. When a speed sensor is applied as the sensing device 27, a photovoltaic power generation element is used as the energy harvesting element. The sensing device 27 provided to the fuselage 15 of the aircraft 10 includes an outdoor temperature sensor, an air pressure sensor, an altitude sensor, and a position sensor. When these sensors are applied as the sensing device 27, a photovoltaic power generation element is used as the energy harvesting element. The sensing device 27 provided to the main wing 16 of the aircraft 10 includes a fuel sensor. When a fuel sensor is applied as the sensing device 27, a piezoelectric element, a photovoltaic power generation element or a Peltier element is used as the energy harvesting element. The sensing device 27 mounted to the stabilizers 17 and 18 or a tail provided closer on the tail of the fuselage 15 of the aircraft 10 includes a temperature sensor. When a temperature sensor is applied as the sensing device 27, a photovoltaic power generation element or a Peltier element is used as the energy harvesting element. The sensing device 27 mounted to the engine of the aircraft 10 includes a rotation speed sensor and a temperature sensor. When these sensors are applied as the sensing device 27, a piezoelectric element, a photovoltaic power generation element, or a Peltier element is used as the energy harvesting element. In this manner, the mounting position of the sensor module 21 and the applied energy harvesting element are determined such that the mounting position and the energy harvesting element can cause stable power generation, and the type of sensor module 21 is determined such that the sensor module 21 can suitably perform measurement at the corresponding mounting position.

According to the first embodiment as described above, the sensing device 27 and the wireless device 28 may be operated using power generated by the energy harvesting element 25. As a result, the sensing device 27 and the wireless device 28 need not be supplied with power via a wire, and hence the power supply system can be simplified. Further, since the sensor data can be wirelessly transmitted by the wireless device 28, there is no need to transmit the sensor data via a wire, and hence a wired communication cables can be omitted and weight can be reduced.

According to the first embodiment, the energy harvesting element 25 can generate power from vibration generated closer to the tip of the main wing 16 of the aircraft 10 as well as vibration and heat around the engine of the aircraft 10.

According to the first embodiment, since the energy harvesting element 25 can be multiplexed, power can be supplied from the energy harvesting element 25 to the power storage device 26 more reliably.

According to the first embodiment, since normalization processing on the plurality of sensor data can be performed to generate the normalized sensor data, the reliability of the normalized sensor data can be increased.

According to the first embodiment, the outdoor temperature of the aircraft 10 can be appropriately measured by providing the outdoor temperature sensor module 21 closer to the tip of the main wing 16, and the energy harvesting element 25 of the outdoor temperature sensor module 21 can suitably generate power at the tip of the main wing 16 which is likely to vibrate.

According to the first embodiment, since the sensor module 21 can be multiplexed, reliability in transmitting the sensor data from the sensor module 21 to the data receiver 22 can be increased.

Note that, in addition to the configuration according to the first embodiment, the wireless device 28 may be configured to transmit the sensor data in a long cycle having a longer length than an initial cycle that is initially set. According to this configuration, since the wireless device 28 can communicate less frequently, power consumption used for communication can be reduced. Therefore, an energy harvesting element 25 with low power generating capacity can be used.

In the first embodiment, the sensor module 21 is configured to indirectly supply the sensing device 27 and the wireless device 28 with power generated by the plurality of energy harvesting elements 25 via the power storage device 26, but the sensor module 21 is not particularly limited to this configuration.

For example, the sensor module 21 may be configured to directly supply power generated by the plurality of energy harvesting elements 25 to the sensing device 27 and the wireless device 28.

### Second Embodiment

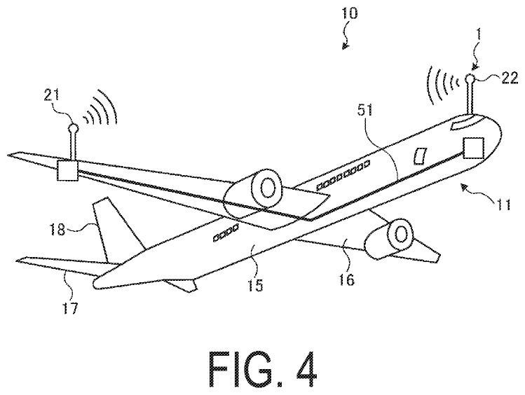

A sensor system 1 according to a second embodiment is described next with reference to FIG. 4. In the second embodiment, in order to avoid redundant descriptions, descriptions will be given only for structural elements different from those of the first embodiment, and the same reference numerals will be assigned to structural elements having the same configuration as that of the first embodiment. FIG. 4 is a schematic view of an aircraft provided with the sensor system according to the second embodiment.

In addition to the sensor system according to the first embodiment, the sensor system 1 according to the second embodiment further includes an emergency power supply and a wired power supply line 51 configured to supply power from the emergency power supply to the sensor module 21 via a wire.

For example, the aircraft body power supply 31 of the data receiver 22 is used as the emergency power supply. The wired power supply line 51 is, for example, an optical fiber that supplies power from the aircraft body power supply 31 to the sensor module 21, and connects the sensor module 21 to the data receiver 22 so that the sensor data generated by the sensor module 21 can be transmitted to the data receiver 22.

As described above, according to the second embodiment, since power can be supplied from the aircraft body power supply 31 to the sensor module 21 in an emergency via a wire, reliability of the sensor system 1 in an emergency can be increased.

### REFERENCE SIGNS LIST

1 Sensor system
10 Aircraft
11 Aircraft body
15 Fuselage
16 Main wing
17 Horizontal stabilizer
18 Vertical stabilizer
21 Sensor module
22 Data receiver
23 Relay system
25 Energy harvesting element
26 Power storage device
27 Sensing device
28 Wireless device
31 Aircraft body power supply
32 Wireless device
33 Data collection/processing device
51 Wired power supply line

1. An aircraft sensor system comprising an aircraft sensor module provided in an aircraft, wherein
the sensor module is an outdoor temperature sensor module configured to measure outdoor temperature of the aircraft, and includes
an energy harvesting element configured to generate power from vibration generated by the aircraft;
a power storage unit configured to store power generated by the energy harvesting element;
a sensor configured to operate by at least one of the power from the energy harvesting element and the power from the power storage unit; and
a wireless communication unit configured to operate by at least one of the power from the energy harvesting element and the power from the power storage unit, and also transmit measurement data measured by the sensor to an external device via wireless communication, and
the sensor module is provided to a wing tip end portion that is a free end of a wing body of the aircraft.

2. (canceled)

3. The aircraft sensor system according to claim 1, wherein a plurality of the energy harvesting elements are provided, and the plurality of energy harvesting elements are connected to the power storage unit and configured to supply power to the power storage unit.

4. The aircraft sensor system according to claim 1, wherein the wireless communication unit is configured to transmit the measurement data in a long cycle having a longer length than an initial cycle that is initially set.

5. The aircraft sensor system according to claim 1, further comprising a data receiver configured to receive the measurement data transmitted from the sensor module.

6. The aircraft sensor system according to claim 1, wherein the sensor module is configured to transmit the measurement data measured by the sensor to the data receiver a plurality of times,
the data receiver is configured to generate normalized measurement data by performing normalization on the basis of a plurality of the measurement data received from the sensor module.

7. (canceled)

8. The aircraft sensor system according to claim 1, wherein
a plurality of the sensor modules of same type are provided, and
each of the plurality of the sensor modules is configured to transmit the measurement data to the data receiver.

9. The aircraft sensor system according to claim 1, further comprising:
an emergency power supply; and
a wired power supply line configured to supply power from the emergency power supply to the sensor module via a wire.
